(19) United States
(12) Patent Application Publication
(10) Pub. No.: US 2026/0350512 A1
(43) Pub. Date: Nov. 5, 2026

(54) DIGITAL TRANSFORMATION SUPPORT SYSTEM, DIGITAL TRANSFORMATION SUPPORT METHOD, AND COMPUTER READABLE MEDIUM

(71) Applicant: Mitsubishi Electric Corporation, Tokyo (JP)

(72) Inventors: Takaomi SATO, Tokyo (JP); Ryosuke NATSUYAMA, Tokyo (JP)

(73) Assignee: Mitsubishi Electric Corporation, Tokyo (JP)

(21) Appl. No.: 19/667,291

(22) Filed: May 4, 2026

Related U.S. Application Data
(63) Continuation of application No. PCT/JP2023/046440, filed on Dec. 25, 2023.

(51) Int. Cl. G06Q 10/0631; G06Q 10/0633

(52) U.S. Cl. CPC G06Q 10/06316; G06Q 10/0633

(57) ABSTRACT

A risk assessment unit (130) calculates, for each work process in a work process flow, at least one indicator value of a bottleneck indicator value, which is an indicator value related to a bottleneck in the work process flow, a person-dependency indicator value, which is an indicator value related to person-dependency in the work process, and a coordination indicator value, which is an indicator value related to coordination between workers, based on information indicated in a work log recorded for each execution of the work process flow, and calculates, for each work process in the work process flow, an assessment value of the work process using the indicator value that has been calculated. A recommendation unit (140) presents a work process in which use of a digital tool is recommended based on the assessment value of each work process in the work process flow.

### CROSS REFERENCE TO RELATED APPLICATION

This application is a Continuation of PCT International Application No. PCT/JP2023/046440, filed on Dec. 25, 2023, which is hereby expressly incorporated by reference into the present application.

### TECHNICAL FIELD

The present disclosure relates to supporting digital transformation.

### BACKGROUND ART

Efforts have been made to extract know-how and improve operational efficiency based on the premise that manual work by skilled workers is optimal.

Patent Literature 1 discloses technology for efficiently and reliably accumulating, as knowledge information, information such as skills and knowledge acquired by skilled workers in work such as maintenance and inspection of various devices. This technology extracts knowledge information common to multiple skilled workers from recordings of video and audio information of the same work so that the knowledge information can be properly managed and edited.

The technology of Patent Literature 1 is based on the premise that a target production system has been entirely digitalized, and does not disclose or suggest replacing manual work with digital technology.

### CITATION LIST

### Patent Literature

Patent Literature 1: WO 2021/079414 A 1

### SUMMARY OF INVENTION

### Technical Problem

An object of the present disclosure is to make it possible to present a work process in which use of a digital tool is recommended, including work processes that are currently performed manually.

### Solution to Problem

A digital transformation support system of the present disclosure includes: a risk assessment unit to calculate, for each work process in a work process flow, at least one indicator value of a bottleneck indicator value, which is an indicator value related to a bottleneck in the work process flow, a person-dependency indicator value, which is an indicator value related to person-dependency in the work process, and a coordination indicator value, which is an indicator value related to coordination between workers, based on information indicated in a work log recorded for each execution of the work process flow that has been executed one or more times, and calculate, for each work process in the work process flow, an assessment value of the work process using the indicator value that has been calculated; and a recommendation unit to present a work process in which use of a digital tool is recommended based on the assessment value of each work process in the work process flow.

### Advantageous Effects of Invention

According to the present disclosure, it is possible to present a work process in which use of a digital tool is recommended, including work processes that are currently performed manually.

### BRIEF DESCRIPTION OF DRAWINGS

FIG. 1 is a configuration diagram of a digital transformation support system 100 in Embodiment 1.

FIG. 2 is a functional configuration diagram of a production system 200 in Embodiment 1.

FIG. 3 is a functional configuration diagram of the digital transformation support system 100 in Embodiment 1.

FIG. 4 is a flowchart of a digital transformation support method in Embodiment 1.

FIG. 5 is a diagram illustrating items of work process information indicated in a work log in Embodiment 1.

FIG. 6 is a diagram illustrating an example of a work process flowchart in Embodiment 1.

FIG. 7 is a diagram illustrating a flowchart of step S130 in Embodiment 1.

FIG. 8 is a diagram illustrating relationships of indicator values in Embodiment 1.

FIG. 9 is a diagram illustrating items of information obtained by processing in step S131 to step S134 in Embodiment 1.

FIG. 10 is a diagram illustrating items of information obtained by step S135 in Embodiment 1.

FIG. 11 is a diagram illustrating targets of digital transformation support in conventional technology.

FIG. 12 is a diagram illustrating targets of digital transformation support in Embodiment 1.

FIG. 13 is a configuration diagram of the digital transformation support system 100 in Embodiment 2.

FIG. 14 is a functional configuration diagram of the digital transformation support system 100 in Embodiment 2.

FIG. 15 is a flowchart of improvement evaluation in Embodiment 2.

FIG. 16 is a diagram illustrating items of information obtained by step S220 in Embodiment 2.

FIG. 17 is a diagram illustrating relationships to an investable cost in Embodiment 2.

FIG. 18 is a diagram illustrating items of information obtained by step S230 in Embodiment 2.

FIG. 19 is a hardware configuration diagram of the digital transformation support system 100 in the embodiments.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

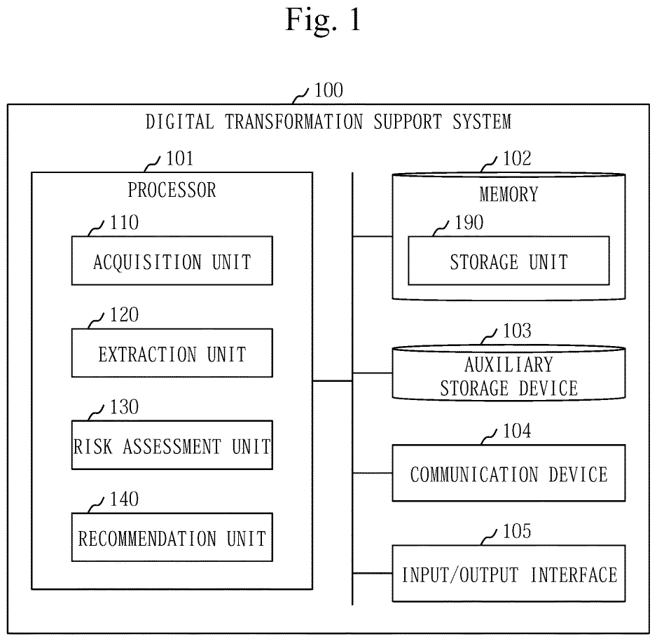

A digital transformation support system 100 will be described based on FIGS. 1 to 12.

### ***Description of Configuration***

Based on FIG. 1, a configuration of the digital transformation support system 100 will be described.

The digital transformation support system 100 is a computer that includes hardware such as a processor 101, a memory 102, an auxiliary storage device 103, a communication device 104, and an input/output interface 105. These hardware components are connected with one another through signal lines.

The processor 101 is an IC that performs operational processing, and controls other hardware components. For example, the processor 101 is a CPU.

IC is an abbreviation for integrated circuit.

CPU is an abbreviation for central processing unit.

The memory 102 is a volatile or non-volatile storage device. The memory 102 is also called a main storage device or a main memory. For example, the memory 102 is a RAM. Data saved in the memory 102 is stored in the auxiliary storage device 103 as necessary.

RAM is an abbreviation for random access memory.

The auxiliary storage device 103 is a non-volatile storage device. For example, the auxiliary storage device 103 is a ROM, an HDD, a flash memory, or a combination of these. Data stored in the auxiliary storage device 103 is loaded into the memory 102 as needed.

ROM is an abbreviation for read only memory.

HDD is an abbreviation for hard disk drive.

The communication device 104 is a receiver and a transmitter. For example, the communication device 104 may be a communication chip or a NIC. The digital transformation support system 100 communicates using the communication device 104.

NIC is an abbreviation for network interface card.

The input/output interface 105 is a port to which an input device and an output device are connected. For example, the input/output interface 105 is a USB terminal, the input device is a keyboard and a mouse, and the output device is a display. Input to and output from the digital transformation support system 100 are performed using the input/output interface 105.

USB is an abbreviation for Universal Serial Bus.

The digital transformation support system 100 includes elements such as an acquisition unit 110, an extraction unit 120, a risk assessment unit 130, and a recommendation unit 140. These elements are realized by software.

The auxiliary storage device 103 stores a digital transformation support program to cause a computer to function as the acquisition unit 110, the extraction unit 120, the risk assessment unit 130, and the recommendation unit 140. The digital transformation support program is loaded into the memory 102 and executed by the processor 101.

The auxiliary storage device 103 further stores an OS. At least part of the OS is loaded into the memory 102 and executed by the processor 101.

The processor 101 executes the digital transformation support program while executing the OS.

OS is an abbreviation for operating system.

Input data and output data of the digital transformation support program are stored in a storage unit 190.

The memory 102 functions as the storage unit 190. However, storage devices such as the auxiliary storage device 103, a register within the processor 101, and a cache memory within the processor 101 may function as the storage unit 190 in place of the memory 102 or in conjunction with the memory 102.

The digital transformation support program can be recorded (stored) in a computer readable format in a non-volatile recording medium such as an optical disc or a flash memory.

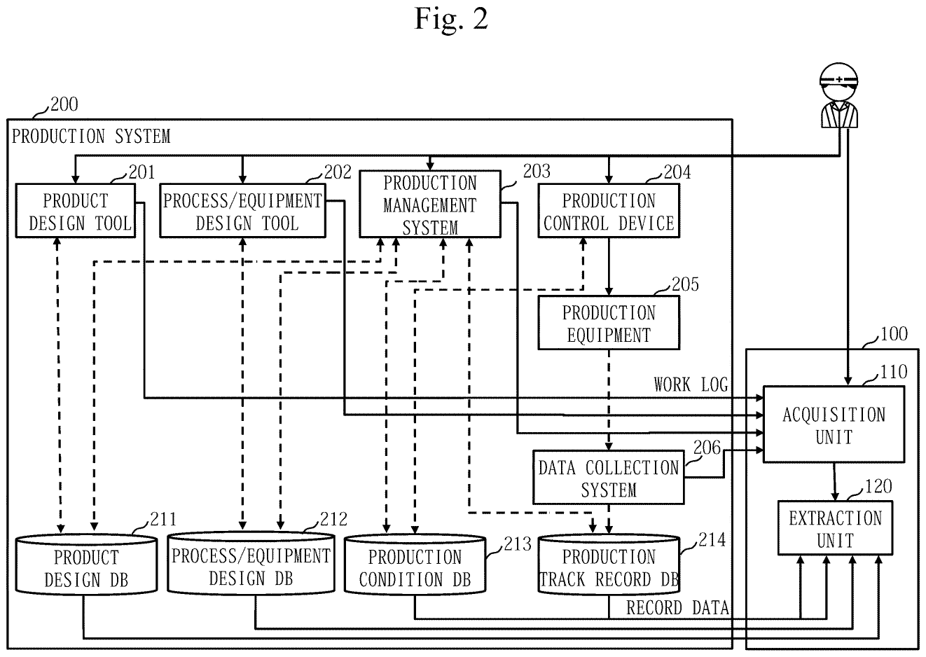

FIG. 2 illustrates a functional configuration of a production system 200.

The production system 200 is an example of a system to be supported (support target system) by the digital transformation support system 100.

The production system 200 includes a product design tool 201, a process/equipment design tool 202, a production management system 203, a production control device 204, production equipment 205, and a data collection system 206. The production system 200 further includes a product design DB 211, a process/equipment design DB 212, a production condition DB 213, and a production track record DB 214. DB stands for database.

The product design tool 201 is software used to design products. For example, the product design tool 201 is software such as CAD or CAE. CAD is an abbreviation for computer aided design. CAE is an abbreviation for computer aided engineering.

The product design DB 211 stores data obtained from the product design tool 201. For example, the product design DB 211 stores data on drawings drawn using CAD, data on conditions and results of simulations using CAE, and so on.

The process/equipment design tool 202 is software used to design an overall configuration (layout) of a production process, individual equipment assembly, configuration of components, or the like. For example, the process/equipment design tool 202 is software such as CAD.

The process/equipment design DB 212 stores data obtained from the process/equipment design tool 202. For example, the process/equipment design DB 212 stores data on drawings drawn using CAD. This data indicates configurations and dimensions of production processes as well as installation positions, dimensions, and device specifications (heater capacity, motor capacity, etc.) of individual machines.

The production management system 203 is a system that centrally manages operations related to production. For example, the production management system 203 has functions such as sales management, production planning, required quantity calculation, purchase management, inventory management, manufacturing management, shipping management, cost management, and budget management.

The production condition DB 213 stores information necessary for manufacturing various products. For example, the production condition DB 213 stores information called BOP, such as work procedures and machine setting conditions. The information necessary for manufacturing various products is managed in association with various production processes (process flows). BOP is an abbreviation for bill of process.

The production track record DB 214 stores data such as production quantities of each product model and consumption amounts of various types of energy in association with time information.

The production control device 204 is a PLC or a DCS. PLC is an abbreviation for programmable logic controller. DCS is an abbreviation for distributed control system.

The production equipment 205 is equipment used to make products. For example, the production equipment 205 includes assembly machines, conveyance machines, and inspection devices.

The data collection system 206 is a system that collects and processes (visualizes, analyzes, etc.) production track record data. For example, the data collection system 206 is SCADA. SCADA is an abbreviation for supervisory control and data acquisition.

An engineer uses the production system 200 to carry out product design, process equipment design, production condition setting, production improvement operations, and so on.

A work log of the production system 200 is recorded by the acquisition unit 110 of the digital transformation support system 100.

Track record data of the production system 200 is recorded by the extraction unit 120 of the digital transformation support system 100.

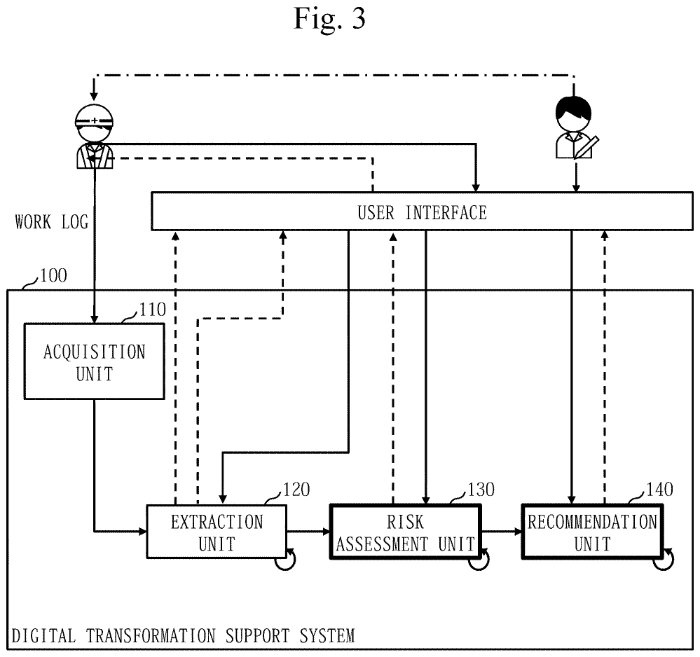

FIG. 3 illustrates a functional configuration of the digital transformation support system 100.

The main features of the digital transformation support system 100 are the risk assessment unit 130 and the recommendation unit 140.

The engineer records the work log using the acquisition unit 110.

A process describer observes the engineer. The process describer also interviews the engineer. The process describer uses a user interface to modify (correct, supplement) data obtained by each of the extraction unit 120, the risk assessment unit 130, and the recommendation unit 140.

### ***Description of Operation***

A procedure for the operation of the digital transformation support system 100 is equivalent to a digital transformation support method. The procedure for the operation of the digital transformation support system 100 is also equivalent to a procedure for processing by the digital transformation support program.

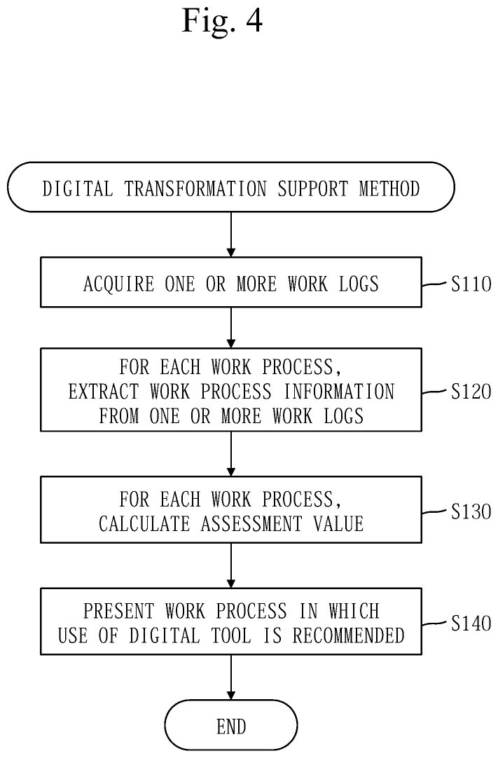

Based on FIG. 4, the digital transformation support method will be described.

The support target system executes a work process flow one or more times. Then, a work log is recorded for each execution of the work process flow.

The work process flow is composed of a plurality of work processes that are to be executed in a determined order.

The work log indicates, for each executed work process in the work process flow, information about the executed work process (work process information).

In step S110, the acquisition unit 110 acquires one or more work logs corresponding to the work process flow that has been executed one or more times.

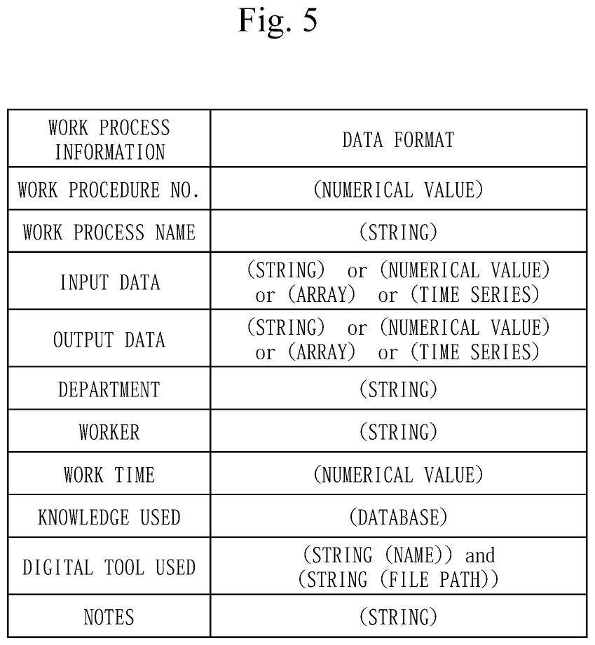

FIG. 5 illustrates an example of a data format for each piece of work process information indicated in the work log.

The work log indicates work process information such as a “work procedure No.”, a “work process name”, “input data”, “output data”, a “department”, a “worker”, “work time”, “knowledge used”, a “digital tool used”, and “notes”.

The “work procedure No.” indicates an order number of a work process in the work process flow. That is, the work procedure No. is a serial number of the work process.

The “work process name” is a name of the work process. The work process name is extracted from video, audio, operation log information, or the like by the process describer or a machine and converted into text. An example of the machine is an artificial intelligence chatbot.

The “input data” means input data of the work process. The input data is data required to execute the work process.

The “output data” means output data of the work process. The output data is data obtained as a result of executing the work process.

The “department” indicates a name of a department to which the worker belongs.

The “worker” indicates a name of the worker.

The “work time” indicates time during which the worker is involved in the work process.

The “knowledge used” indicates information (knowledge information) used by the worker in the work process. The input data is excluded from the knowledge information.

The “digital tool used” indicates a name of a digital tool used by the worker in the work process. Information such as where to connect to use the digital tool may be indicated.

The “notes” means notes about the work process.

The information in the work log is obtained as described below.

The information in the work log is recorded by the support target system.

A camera and a microphone are installed in the support target system, and the work process flow is executed. During the execution of the work process flow, image data is obtained by the camera and audio data is obtained by the microphone. The information in the work log is obtained by analyzing the image data and the audio data.

The information in the work log is described by the engineer of the support target system.

Referring back to FIG. 4, the description will be continued from step S120.

In step S120, the extraction unit 120 detects the plurality of work processes that make up the work process flow from the one or more work logs (and track record data).

Then, for each work process in the work process flow, the extraction unit 120 extracts work process information from the one or more work logs (and track record data).

For example, the extraction unit 120 extracts each piece of work process information by performing process mining in accordance with definitions of a basic process model.

The basic process model is a model that defines a basic work process flow, and is prepared in advance.

The process mining can be performed using an existing method. An example of the existing method is the Alpha algorithm.

Each piece of work process information that has been extracted may be modified manually or mechanically. For example, each piece of work process information may be modified as described below.

The extraction unit 120 generates a work process flowchart using pieces of work process information of the work process flow, and displays the work process flowchart on a display.

The work process flowchart illustrates a flow of execution of the plurality of work processes, and indicates work process information in association with shapes each representing a corresponding work process.

The process describer selects a work process from the work process flowchart, and issues an instruction to modify (correct, supplement, etc.) the work process information of the selected work process.

The extraction unit 120 accepts the instruction and modifies the work process information in accordance with the instruction.

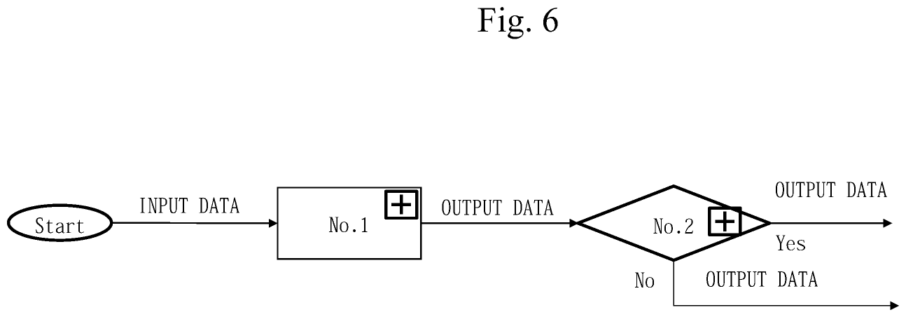

FIG. 6 illustrates an example of the work process flowchart.

The work process flowchart represents a flow of a work process No.1 and a work process No.2.

A mark (+) for displaying work process information is attached to the shape of each work process.

When the process describer selects one of the marks (+), the extraction unit 120 displays the work process information of the shape to which the selected mark (+) is attached.

When the process describer edits the displayed work process information, the extraction unit 120 updates the work process information according to the editing.

Referring back to FIG. 4, the description will be continued from step S130.

In step S130, for each work process in the work process flow, the risk assessment unit 130 calculates an assessment value of the work process regarding digital transformation based on the work process information.

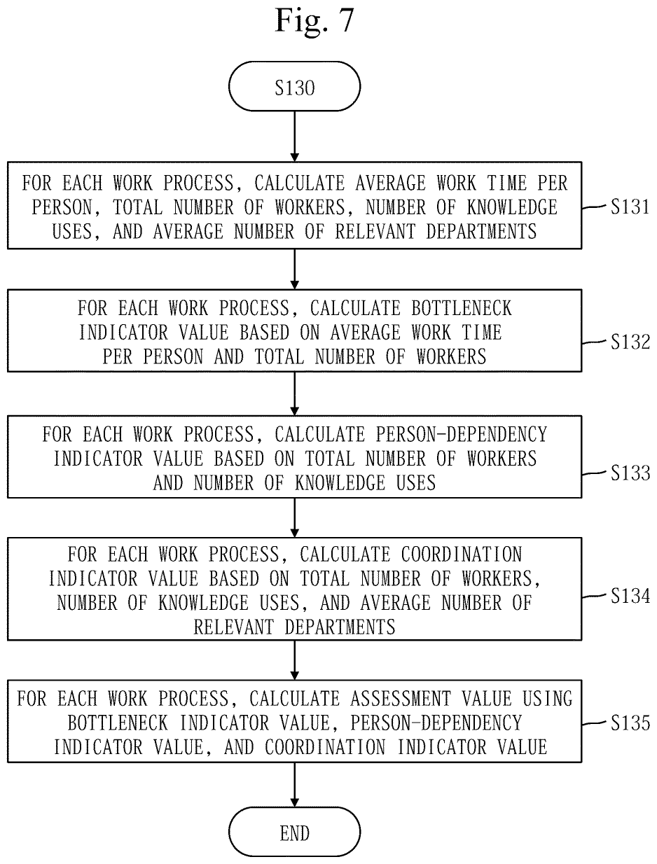

Based on FIG. 7, a procedure of step S130 will be described.

In step S131, for each work process in the work process flow, the risk assessment unit 130 calculates average work time per person, a total number of workers, the number of knowledge uses, and an average number of relevant departments based on the work process information indicated in the one or more work logs.

The average work time per person is calculated by dividing total work time by a cumulative number of workers.

The total work time is a total of “work time” required for the work process.

The cumulative number of workers is a total of how many “workers” are involved in the work process. If the same worker is involved in different work sessions, the same number of workers as the number of work sessions in which the same worker is involved is counted.

The total number of workers is the number of “workers” involved in the work process. If the same worker is involved in different work sessions, the same worker is counted as one.

The number of knowledge uses is the number of pieces of “knowledge information” used in the work process.

An average number of relevant departments is calculated by dividing a cumulative number of relevant departments by the number of work sessions (the number of pieces of work process information, the number of work logs).

The cumulative number of relevant departments is a total of “departments” involved in the work process. If the same department is involved in different work sessions, the same number as the number of work sessions in which the same department is involved is counted.

In step S132, the risk assessment unit 130 calculates a bottleneck indicator value for each work process in the work process flow, based on the average work time per person and the total number of workers.

The bottleneck indicator value is an indicator value related to a bottleneck in the work process flow.

Specifically, the risk assessment unit 130 calculates a value that is larger as the average work time per person is longer and that is larger as the total number of workers is larger. The calculated value is the bottleneck indicator value.

For example, the risk assessment unit 130 calculates the bottleneck indicator value by multiplying the average work time per person by the total number of workers.

In step S133, the risk assessment unit 130 calculates a person-dependency indicator value for each work process in the work process flow, based on the total number of workers and the number of knowledge uses.

The person-dependency indicator value is an indicator value related to person-dependency in the work process.

Specifically, the risk assessment unit 130 calculates a value that is smaller as the total number of workers is larger and that is larger as the number of knowledge uses is larger. The calculated value is the person-dependency indicator value.

For example, the risk assessment unit 130 calculates the person-dependency indicator value by dividing the number of knowledge uses by the total number of workers.

In step S134, the risk assessment unit 130 calculates a coordination indicator value for each work process in the work process flow, based on the total number of workers, the number of knowledge uses, and the average number of relevant departments.

The coordination indicator value is an indicator value related to coordination between workers.

Specifically, the risk assessment unit 130 calculates a value that is larger as the total number of workers is larger, that is larger as the number of knowledge uses is larger, and that is larger as the average number of relevant departments is larger. The calculated value is the coordination indicator value.

For example, the risk assessment unit 130 calculates the coordination indicator value by multiplying the total number of workers, the number of knowledge uses, and the average number of relevant departments.

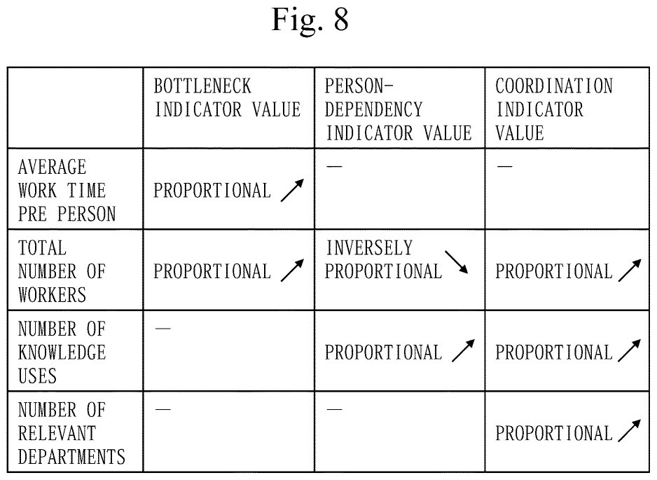

FIG. 8 illustrates relationships between each indicator value and each of the average work time per person, the total number of workers, the number of knowledge uses, and the average number of relevant departments.

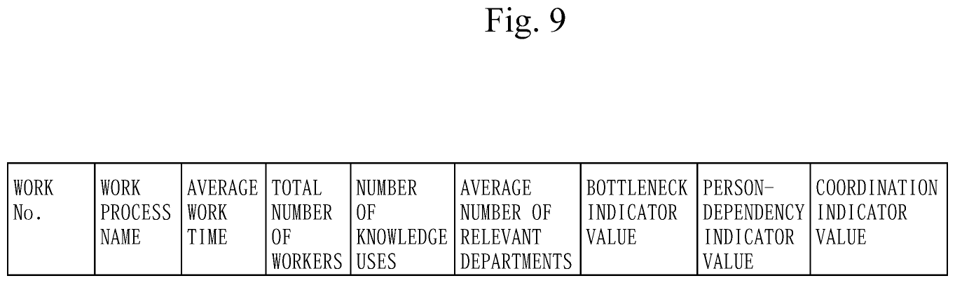

FIG. 9 illustrates a list of items of information obtained by the processing in step S131 to step S134.

The information obtained by the processing in step S131 to step S134 may be modified manually or mechanically. For example, the information is modified as described below.

The risk assessment unit 130 displays a table composed of the items indicated in FIG. 9 on the display.

The process describer issues an instruction to modify (correct, supplement, etc.) the information indicated in the displayed table.

The risk assessment unit 130 accepts the instruction and modifies the information in accordance with the instruction.

Referring back to FIG. 7, step S135 will be described.

In step S135, the risk assessment unit 130 calculates an assessment value for each work process in the work process flow, using the bottleneck indicator value, the person-dependency indicator value, and the coordination indicator value.

The assessment value is calculated as described below.

First, the risk assessment unit 130 normalizes each of the bottleneck indicator value, the person-dependency indicator value, and the coordination indicator value for each work process.

For example, the risk assessment unit 130 normalizes each indicator value in a five-level assessment using the percentile method as described below.

If the indicator value of a target work process falls within the top 20 percent of a plurality of indicator values corresponding to the plurality of work processes in the work process flow, the indicator value of the target work process after normalization is “5”.

Similarly, if the indicator value of the target work process falls within the range of the top 20 percent to the top 40 percent, the indicator value of the target work process after normalization is “4”.

Similarly, if the indicator value of the target work process falls within the range of the top 40 percent to the top 60 percent, the indicator value of the target work process after normalization is “3”.

Similarly, if the indicator value of the target work process falls within the range of the top 60 percent to the top 80 percent, the indicator value of the target work process after normalization is “2”.

Similarly, if the indicator value of the target work process falls within the bottom 20 percent, the indicator value of the target work process after normalization is “1”.

Then, the risk assessment unit 130 calculate the sum of the normalized bottleneck indicator value, the normalized person-dependency indicator value, and the normalized coordination indicator value for each work process. The calculated sum is the assessment value.

The risk assessment unit 130 may calculate the assessment value by weighting each of the normalized bottleneck indicator value, the normalized person-dependency indicator value, and the normalized coordination indicator value. In this case, the sum of the weighted normalized bottleneck indicator value, the weighted normalized person-dependency indicator value, and the weighted normalized coordination indicator value is the assessment value. A weighted normalized indicator value is a value obtained by multiplying a normalized indicator value by a weighting coefficient.

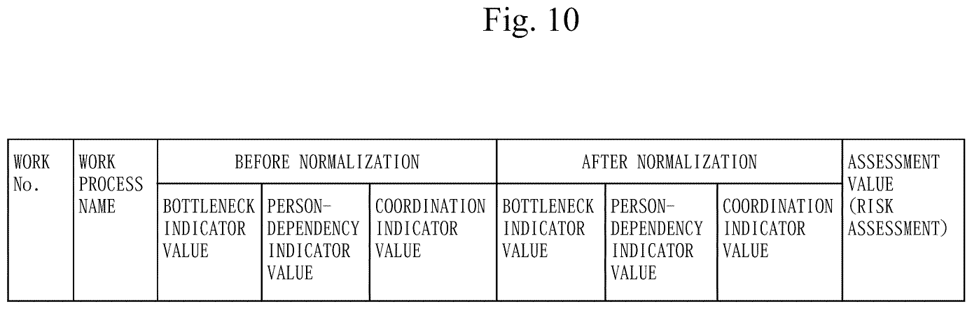

FIG. 10 illustrates a list of items of information obtained by step S135.

The information obtained by step S135 may be modified manually or mechanically. For example, the information is modified as described below.

The risk assessment unit 130 displays a table composed of the items indicated in FIG. 10 on the display.

The process describer issues an instruction to modify (correct, supplement, etc.) the information indicated in the displayed table.

The risk assessment unit 130 receives the instruction and modifies the information in accordance with the instruction.

Referring back to FIG. 4, step S140 will be described.

In step S140, the recommendation unit 140 presents work processes in which the use of a digital tool is recommended based on the assessment value of each work process in the work process flow.

For example, the recommendation unit 140 arranges the plurality of work processes in the work process flow in descending order of the assessment values, and displays a table composed of the items indicated in FIG. 10 on the display. That is, the recommendation unit 140 presents a priority order of the work processes in which the use of a digital tool is recommended.

The recommendation unit 140 may select each work process whose assessment values is equal to or greater than a threshold value or a fixed number of work processes whose assessment values are at the top, and present the selected work processes.

The recommendation unit 140 may exclude each work process whose assessment value is equal to or smaller than a threshold value or a fixed number of work processes whose assessment values are at the bottom, and present the remaining work processes.

If a work process in which a digital tool is not used is presented as a work process in which the use of a digital tool is recommended, the use of the digital tool is recommended in the presented work process.

If a work process in which a digital tool is used is presented as a work process in which the use of a digital tool is recommended, the use of a different digital tool (replacement or updating of the digital tool) is recommended in the presented work process.

The information to be presented or the presented information may be modified manually or mechanically. For example, the information may be modified as described below.

The recommendation unit 140 displays the information to be presented on the display.

The process describer issues an instruction to modify (correct, supplement, etc.) the displayed information.

The recommendation unit 140 accepts the instruction and modifies the information in accordance with the instruction.

### ***Effects of Embodiment 1***

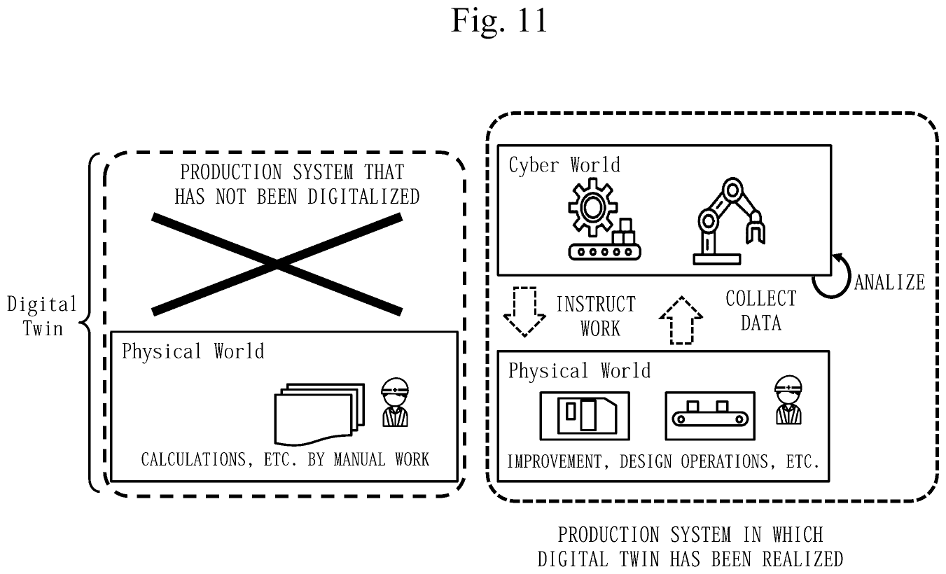

FIG. 11 illustrates targets of digital transformation support in conventional technology.

The conventional technology assumes that the work of skilled workers in manual work (physical world) has been optimized, and focuses on extracting know-how and improving operational efficiency only in the area of manual work. However, if it is assumed that digital tools (computers) are utilized, there is a possibility that further improvement in operational efficiency can be achieved.

The conventional technology assumes that digital technology (cyber world) corresponding to the manual work in a production system has been developed and constructed. However, in the production sites of customers who want to advance digital transformation (DX), there are many cases where production systems that are used include both areas in which digital tools are used and areas in which manual work remains.

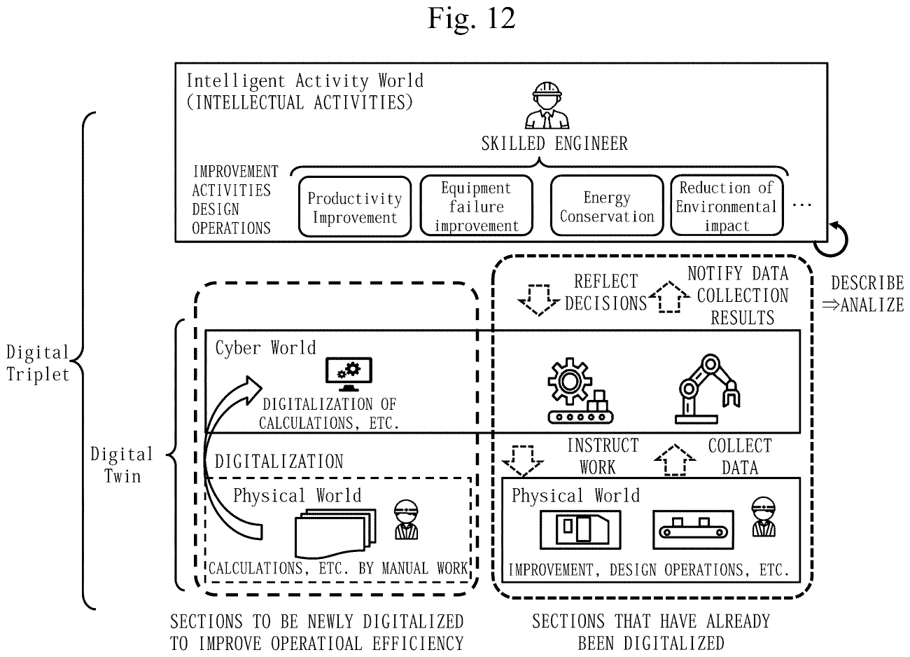

FIG. 12 illustrates targets of digital transformation support in Embodiment 1.

Embodiment 1 targets a production system where manual work (physical world) and digital technology (cyber world) coexist, and aims to realize improvement in operational efficiency utilizing digital technology (DX). The improvement in operational efficiency through digitalization is realized by observing, documenting, and evaluating decision-making processes of skilled engineers.

Specifically, Embodiment 1 aims to present, to a user, sections where replacement with or updating of digital technology is recommended.

The extraction unit 120 creates a work process flow that describes a compilation of information such as input/output information and used knowledge based on work logs that indicate production improvement and design operations of skilled workers.

The risk assessment unit 130 determines requirement levels (indicator values) of work bottlenecks, person-dependency, and (inter-department) coordination based on information such as time required for each work process, the number of relevant departments, and the number of persons.

Then, the recommendation unit 140 presents sections (work processes) where standardization of work through replacement with or updating of a digital tool is recommended.

If a work process is a bottleneck, and also has high person-dependency or requires inter-department coordination, it is determined that standardization of work has not been achieved or standardization of work will be highly effective in the work process, and replacement with a digital tool or updating of a digital tool is recommended.

In Embodiment 1, risks such as work bottlenecks and person-dependency are quantitatively presented to users who have not achieved DX.

Therefore, Embodiment 1 serves as guidelines that make it easy to determine sections where work is to be standardized by replacement with a digital tool or updating of a digital tool. Embodiment 1 increases the possibility of improving operational efficiency.

### ***Supplement to Embodiment 1***

The digital transformation support system 100 may be composed of a plurality of devices (computers) that communicate with each other.

The digital transformation support system 100 may be applied to systems other than the production system 200, such as a supply chain management system or a programming training system.

The supply chain management system is a management system that manages a flow of products from supply companies (suppliers) to (end) customers so as to improve the efficiency of its operational processes and eliminate waste.

The programming training system is a system that provides a programming training environment online or in other ways.

The risk assessment unit 130 may calculate one or two indicator values of the bottleneck indicator value, the person-dependency indicator value, and the coordination indicator value for each work process, and use the calculated indicator values to calculate an assessment value of the work process.

### Embodiment 2

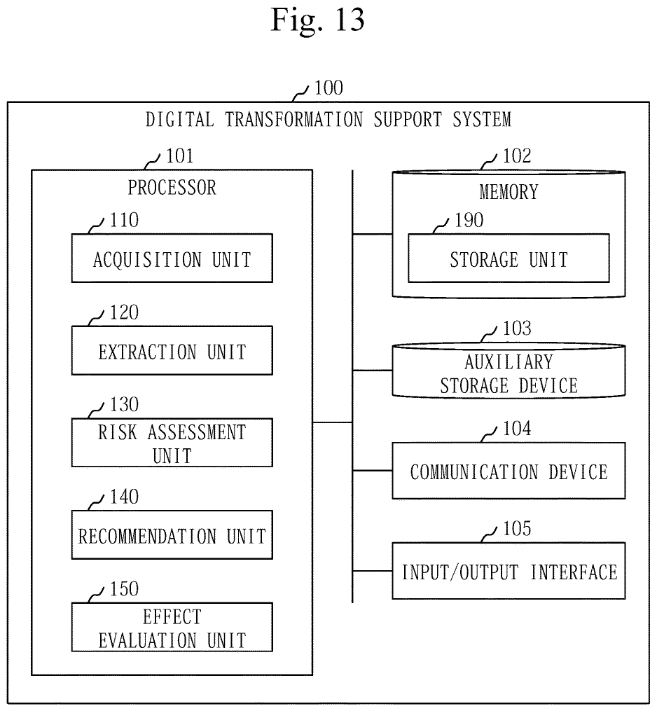

With regard to an embodiment in which effects of improvement using digital tools are evaluated, differences from Embodiment 1 will be mainly described based on FIGS. 13 to 18.

### ***Description of Configuration***

Based on FIG. 13, a configuration of the digital transformation support system 100 will be described.

The digital transformation support system 100 further includes an effect evaluation unit 150.

The digital transformation support program further causes a computer to function as the effect evaluation unit 150.

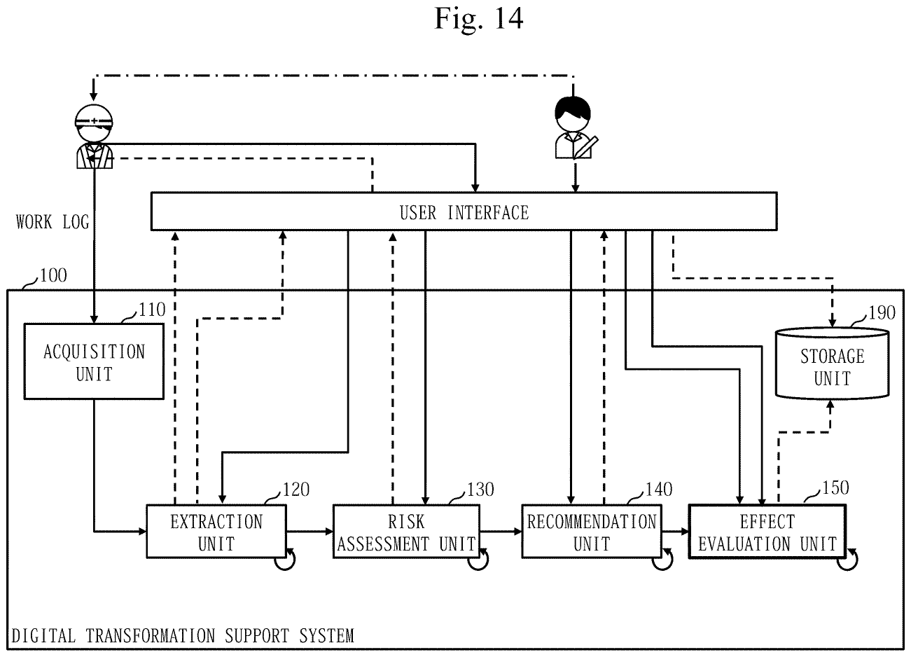

FIG. 14 illustrates a functional configuration of the digital transformation support system 100.

The main feature of the digital transformation support system 100 is the effect evaluation unit 150.

An engineer uses a user interface to input various setting information into the digital transformation support system 100.

A process describer uses the user interface to modify (correct, supplement) data obtained by the effect evaluation unit 150.

### ***Description of Operation***

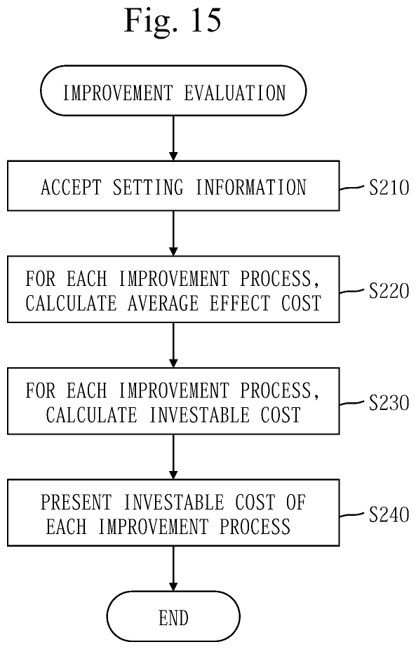

Based on FIG. 15, improvement evaluation will be described.

The improvement evaluation is a process of evaluating an effect of improvement implementation after the improvement implementation.

The improvement implementation means executing the work process flow using digital tools in each work process presented in step S140 of Embodiment 1.

A work process in which a digital tool is used through the improvement implementation is referred to as an improvement process. The improvement process includes a work process in which a digital tool is replaced or updated.

In step S210, the effect evaluation unit 150 accepts setting information such as an investment period and an investment recovery period.

The “investment period” means an investment period for the support target system. The investment period is a period during which investment is made in the support target system. For example, the investment period is a period during which an improvement and a design are reflected in the production system 200.

The “investment recovery period” means an investment recovery period for the support target system. The investment recovery period is a period during which the investment for the support target system is recovered. For example, the investment recovery period is a period from when the improvement and the design are completely reflected in the production system 200 and an effect of the improvement begins to be obtained until an invested amount is recovered.

In step S220, the effect evaluation unit 150 calculates an average effect cost for each improvement process, based on work time of each worker indicated in a work log after the improvement implementation and an effect cost obtained by the improvement implementation.

The effect cost is a cost reduced by the effect of the improvement implementation. The effect cost may be calculated based on information in work logs, or may be included in the setting information.

The average effect cost is an effect cost per fixed period in the improvement process.

The average effect cost will be described supplementarily.

Specifically, the average effect cost is an average value of annual effect amounts obtained after the end of the investment period. In reality, the effect amount is not necessarily the same every year. The average effect cost is a value used to know how much effect will be obtained in total by the end of the investment recovery period. If the total effect cost is used, it is not clear how many years the effect will last. Therefore, the average effect cost is used. The effect amount is calculated based on production track records.

The average effect cost is calculated as described below.

First, the effect evaluation unit 150 calculates the total work time by adding up the work time of each worker for each work process in the work process flow.

The effect evaluation unit 150 also calculates the overall work time by adding up the total work time of each work process.

Then, the effect evaluation unit 150 allocates the effect cost proportionally to each work process in the work process flow according to a proportion of the total working time of each improvement process to the overall work time.

If the effect cost is not allocated proportionally, the effect cost will be linked only to a specific work process (improvement process) in which measures are reflected at the production site.

The cost calculated using proportional allocation regarding each improvement process is the average effect cost.

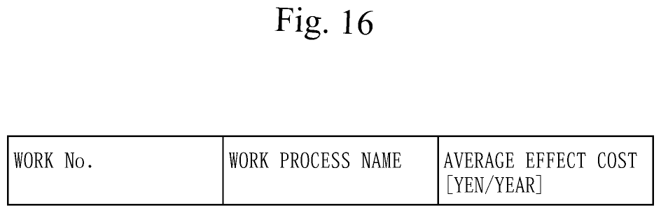

FIG. 16 illustrates a list of items of information obtained by step S220.

Referring back to FIG. 15, the description will be continued from step S230.

In step S230, the effect evaluation unit 150 calculates an investable cost for each improvement process, based on the calculated average effect cost, the investment period included in the setting information, and the investment recovery period included in the setting information.

The investable cost is a cost that can be invested in the improvement process per fixed period. Specifically, the investable cost is a cost that can be invested on an annual average. It is not necessary to invest the exact same amount every year, but (investable cost)×(investment period) always needs to be the same.

The investable cost is higher as the average effect cost is higher, is lower as the investment period is longer, and is higher as the investment recovery period is longer.

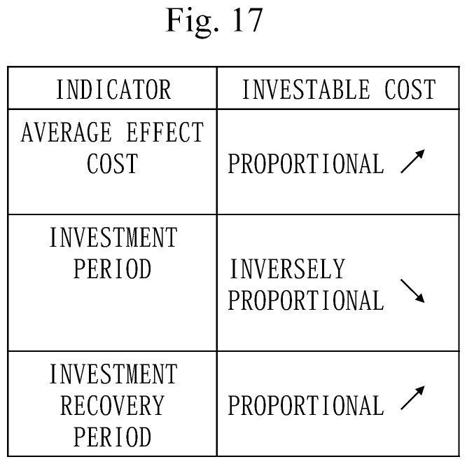

FIG. 17 illustrates relationships between the average effect cost, the investment period, the investment recovery period, and the investable cost.

The investable cost is calculated as described below.

The effect evaluation unit 150 multiplies the average effect cost by a value obtained by dividing the investment recovery period by the investment period. The calculated value is the investable cost.

The investable cost is represented by the following formula.

(Investable cost)=(Average effect cost)×(Investment recovery period)/(Investment period)

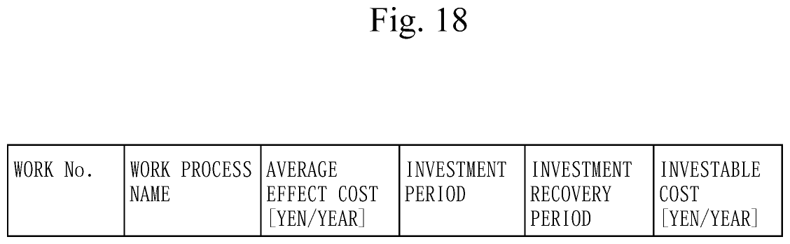

FIG. 18 illustrates a list of items of information obtained by step S230.

In step S240, the effect evaluation unit 150 presents the investable cost of each improvement process.

For example, the effect evaluation unit 150 displays a table composed of the items indicated in FIG. 18 on the display.

The information to be presented or the presented information may be modified manually or mechanically. For example, the information may be modified as described below.

The effect evaluation unit 150 displays the information to be presented on the display.

The process describer issues an instruction to modify (correct, supplement, etc.) the displayed information.

The effect evaluation unit 150 accepts the instruction and modifies the information in accordance with the instruction.

### ***Effects of Embodiment 2***

In Embodiment 2, the effect cost is calculated based on results obtained by applying improvement measures and designs to the production site after assessment according to Embodiment 1 is performed, and the investable cost for digitalization is calculated (by simulation) based on conditions such as the investment recovery period separately set by experts. This allows effects of replacement with or updating of digital tools to be evaluated. As a result, the evidence for recommendations in Embodiment 1 is reinforced.

In Embodiment 2, effects after improvement measures and design implementations are predicted and evaluated from the perspective of cost. This reinforces the evidence for replacement with or updating of digital tools for users.

### ***Supplement to Embodiments***

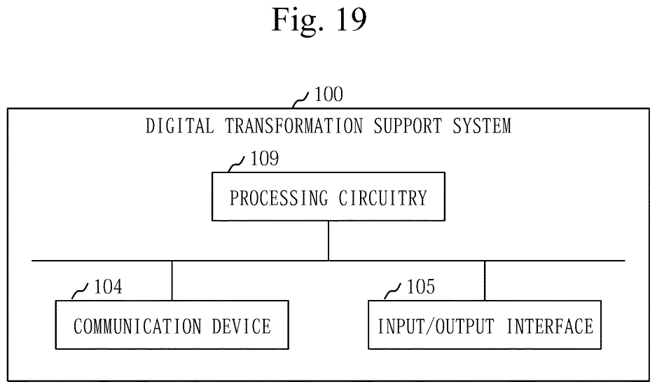

Based on FIG. 19, a hardware configuration of the digital transformation support system 100 will be described.

The digital transformation support system 100 includes processing circuitry 109.

The processing circuitry 109 is hardware that realizes the acquisition unit 110, the extraction unit 120, the risk assessment unit 130, the recommendation unit 140, and the effect evaluation unit 150.

The processing circuitry 109 may be dedicated hardware or may be the processor 101 that executes programs stored in the memory 102.

When the processing circuitry 109 is dedicated hardware, the processing circuitry 109 is, for example, a single circuit, a composite circuit, a programmed processor, parallel-programmed processors, an ASIC, an FPGA, or a combination of these.

ASIC is an abbreviation for application specific integrated circuit.

FPGA is an abbreviation for field programmable gate array.

The digital transformation support system 100 may include a plurality of processing circuits as an alternative to the processing circuitry 109.

In the processing circuitry 109, some functions may be realized by dedicated hardware, and the remaining functions may be realized by software or firmware.

As described above, the functions of the digital transformation support system 100 can be realized by hardware, software, firmware, or a combination of these.

Each of the embodiments is an example of a preferred embodiment and is not intended to limit the technical scope of the present disclosure. Each of the embodiments may be partially implemented, or may be implemented in combination with another embodiment. The procedures described using the flowcharts or the like may be suitably modified. “Unit” of each element of the digital transformation support system 100 may be interpreted as “process”, “step”, “circuit” or “circuitry”.

### REFERENCE SIGNS LIST

100: digital transformation support system; 101: processor; 102: memory; 103: auxiliary storage device; 104: communication device; 105: input/output interface; 109: processing circuitry; 110: acquisition unit; 120: extraction unit; 130: risk assessment unit; 140: recommendation unit; 150: effect evaluation unit; 190: storage unit; 200: production system; 201: product design tool; 202: process/equipment design tool; 203: production management system; 204: production control device; 205: production equipment; 206: data collection system; 211: product design DB; 212: process/equipment design DB; 213: production condition DB; 214: production track record DB.

1. A digital transformation support system comprising
processing circuitry to:
calculate, for each work process in a work process flow, at least one indicator value of a bottleneck indicator value, which is an indicator value related to a bottleneck in the work process flow, a person-dependency indicator value, which is an indicator value related to person-dependency in the work process, and a coordination indicator value, which is an indicator value related to coordination between workers, based on information indicated in a work log recorded for each execution of the work process flow that has been executed one or more times, and calculate, for each work process in the work process flow, an assessment value of the work process using the indicator value that has been calculated; and
present a work process in which use of a digital tool is recommended based on the assessment value of each work process in the work process flow.

2. The digital transformation support system according to claim 1,
wherein for each work process in the work process flow, the work log indicates work time spent in the work process for each worker involved in the work process, as work process information, and
wherein for each work process in the work process flow, the processing circuitry calculates average work time per person and a total number of workers, which is the number of workers involved in the work process, based on the work process information indicated in each of one or more work logs, and calculates the bottleneck indicator value based on the average work time per person and the total number of workers.

3. The digital transformation support system according to claim 2,
wherein the processing circuitry calculates, as the bottleneck indicator value, a value that is larger as the average work time per person is longer and that is larger as the total number of workers is larger.

4. The digital transformation support system according to claim 1,
wherein for each work process in the work process flow, the work log indicates, for each worker involved in the work process, knowledge information used by the worker in the work process, as work process information, and
wherein for each work process in the work process flow, the processing circuitry calculates a total number of workers, which is the number of workers involved in the work process, and the number of knowledge uses, which is the number of pieces of knowledge information used in the work process, based on the work process information indicated in each of one or more work logs, and calculates the person-dependency indicator value based on the total number of workers and the number of knowledge uses.

5. The digital transformation support system according to claim 4,
wherein the processing circuitry calculates, as the person-dependency indicator value, a value that is smaller as the total number of workers is larger and that is larger as the number of knowledge uses is larger.

6. The digital transformation support system according to claim 1,
wherein for each work process in the work process flow, the work log indicates, for each worker involved in the work process, knowledge information used by the worker in the work process and a department to which the worker belongs, and
wherein for each work process in the work process flow, the processing circuitry calculates a total number of workers, which is the number of workers involved in the work process, the number of knowledge uses, which is the number of pieces of knowledge information used in the work process, and an average number of relevant departments, which is an average number of departments involved in the work process, based on information indicated in each of one or more work logs, and calculates the coordination indicator value based on the total number of workers, the number of knowledge uses, and the average number of relevant departments.

7. The digital transformation support system according to claim 6,
wherein the processing circuitry calculates, as the coordination indicator value, a value that is larger as the total number of workers is larger, that is larger as the number of knowledge uses is larger, and that is larger as the average number of relevant departments is larger.

8. The digital transformation support system according to claim 1,
wherein the work process flow is executed in a support target system, and
wherein after improvement implementation using a digital tool in each presented work process, the processing circuitry accepts an investment period in the support target system and an investment recovery period in the support target system as setting information,
calculates, for each work process in which the digital tool is used through the improvement implementation, an average effect cost, which is an effect cost per fixed period in the work process, based on work time of each worker indicated in the work log after the improvement implementation and an effect cost obtained through the improvement implementation,
calculates, for each work process in which the digital tool is used through the improvement implementation, an investable cost based on the average effect cost that has been calculated, the investment period included in the setting information, and the investment recovery period included in the setting information, and
presents the investable cost of each work process in which the digital tool is used through the improvement implementation.

9. A digital transformation support method comprising:
calculating, for each work process in a work process flow, at least one indicator value of a bottleneck indicator value, which is an indicator value related to a bottleneck in the work process flow, a person-dependency indicator value, which is an indicator value related to person-dependency in the work process, and a coordination indicator value, which is an indicator value related to coordination between workers, based on information indicated in a work log recorded for each execution of the work process flow that has been executed one or more times, and calculating, for each work process in the work process flow, an assessment value of the work process using the indicator value that has been calculated; and
presenting a work process in which use of a digital tool is recommended based on the assessment value of each work process in the work process flow.

10. A non-transitory computer readable medium storing a digital transformation support program to cause a computer to execute:
a risk assessment process of calculating, for each work process in a work process flow, at least one indicator value of a bottleneck indicator value, which is an indicator value related to a bottleneck in the work process flow, a person-dependency indicator value, which is an indicator value related to person-dependency in the work process, and a coordination indicator value, which is an indicator value related to coordination between workers, based on information indicated in a work log recorded for each execution of the work process flow that has been executed one or more times, and calculating, for each work process in the work process flow, an assessment value of the work process using the indicator value that has been calculated; and
a recommendation process of presenting a work process in which use of a digital tool is recommended based on the assessment value of each work process in the work process flow.
